(19) United States
(12) Patent Application Publication
(10) Pub. No.: US 2026/0316103 A1
(43) Pub. Date: Oct. 15, 2026

(54) Wearable Spray Device

(71) Applicant: Justin Avila, Scotch Plains, NJ (US)

(72) Inventor: Justin Avila, Scotch Plains, NJ (US)

(21) Appl. No.: 19/466,598

(22) Filed: Feb. 2, 2026

Related U.S. Application Data
(60) Provisional application No. 63/758,303, filed on Feb. 13, 2025.

(51) Int. Cl. B05B 11/00; A44C 5/00

(52) U.S. Cl. CPC B05B 11/0054; A44C 5/003; B05B 11/0062

(57) ABSTRACT

A spray device may have a refill pack containing sprayable liquid. The refill pack may be partially configured within a housing. A spray assembly having a nozzle and a stationary valve may also be partially configured within the housing such that the nozzle and stationary valve are stationary relative to the housing. The spray assembly may extend into the refill pack such that sprayable liquid may enter the spray assembly. The refill pack may be pressed into the housing to cause a spray assembly chamber of the spray assembly to translate relative to the stationary valve and the nozzle. This may cause sprayable liquid to exit the spray device via the nozzle in a direction parallel to a front face of the housing. The spray device may be worn on a user's wrist such that the sprayable liquid makes contact with the user's hand upon exiting the nozzle.

### CROSS-REFERENCE TO RELATED APPLICATIONS

This application claims the benefit of priority of U.S. Provisional Patent Application No. 63/758,303, filed on Feb. 13, 2025, which is hereby incorporated by reference.

### BACKGROUND OF THE INVENTION

The present invention relates to the field of wearable accessories and the field of spray devices. In the field of wearable accessories, there are types of wearable accessories that exist solely to serve an aesthetic purpose, and are referred to herein as “non-functional wearable accessories.” Alternatively, there exist wearable accessories that exist for a functional purpose, such as wristwatches that exist to display the time for a user, and MP3 carriers that exist to allow easy portability of MP3 players while a user is performing an activity that requires both hands. Said wristwatches and MP3 players are just two examples of many different types of “functional wearable accessories”, which are accessories worn by a user in order to achieve a functional purpose other than a desired aesthetic appearance.

The field of spray devices comprises mostly handheld containers that contain a sprayable liquid and a spray mechanism used to eject said sprayable liquid from the containers in the form of a mist or spray. Said spray mechanisms exist in various forms. One common form of spray mechanism exists as compressed air mixed with the sprayable liquid, and a valve located on a top portion of the spray device. When the valve is opened, the pressurized mixture is released through the valve in the form of a mist or spray. This type of spray mechanism, commonly referred to as an “aerosol spray mechanism” can pose potential hazards to users because of the pressurized gas that exists within the spray device.

Another common form of spray mechanism that does not utilize pressurized gas comprises a tube with a first end and a second end, the first end deposed within a body of sprayable liquid, and the second end attached to a piston on a top end of a spray device. The piston may be depressed by a user to pressurize the air within a chamber at the end of the piston that is not connected to the tube. When the piston is then released, the chamber is de-pressurized and liquid is sent through the tube into the chamber due to the difference in pressure. When the piston is depressed again, the liquid that is in the chamber is expelled through a nozzle as a spray. This type of spray mechanism is referred to herein as a “manual spray mechanism.” Because manual spray mechanisms do not contain the level of pressurized gas as aerosol spray mechanisms, they are much safer for users.

Spray devices that comprise manual and aerosol spray mechanisms both comprise the shortcoming of being generally inconvenient to carry on a user's person. Most spray devices that exist in the art exist as handheld bottles or other containers. While these devices are portable, they present an inconvenience in that if a user wishes to carry said devices on their person, they must continuously hold the device in their hand(s) or wear a portable carrier such as a backpack in order to transport the spray device. Some spray devices in the art comprise features that allow the devices to be attached to a keychain. However, these devices still present an inconvenience in that users do not always wear clothing to which keychains may be attached.

Due to the shortcomings described herein, there exists a need in the art for a safe, portable spray device that comprises features to allow the device to be easily carried on a user's person.

### SUMMARY OF THE INVENTION

Embodiments of the present invention comprise a device that may be referred to herein as a “spray device”. The device may comprise a housing with a housing front face. The housing may also have additional housing faces configured parallel or perpendicular to the housing front face. The housing may be attached to a band, which may be configured around an appendage of a user. This appendage may be any body part including but not limited to a user's wrist, arm, leg, ankle, neck, or waist. In preferred embodiments, the band may be worn around a user's wrist.

The housing may be removably or permanently attached to the band. In embodiments wherein the housing is removably attached to the band, band attachment loops may extend from a face of the housing. This face may be opposite the housing front face and may be referred to as the “housing rear face”. The band may be configured through the band attachment loops such that the housing may translate along a length of the band while still being removably attached to the band. There may be a significant amount of friction between the band and the band attachment loops and/or between the band and the housing rear face so that an external force other than gravity is needed to translate the housing along the length of the band.

In embodiments wherein the housing is permanently attached to the band, the housing rear face may be attached to the band using an adhesive. Alternatively, the housing may be integrally formed with the band such that the band itself defines the various faces of the housing, including the housing front face. It is advantageous that the band is made of a flexible material so it can be worn around a user's appendage. Therefore, in embodiments wherein the housing is integrally formed with the band, the band may be formed around a structure of a more rigid material to define the shape of the housing. This more rigid material may be a hard plastic such as but not limited to polyvinyl chloride or acrylonitrile butadiene styrene.

In addition to the housing, one or more auxiliary implements may be removably or permanently attached to the band. An auxiliary implement may be removably or permanently attached to the band in the same manner as the housing is removably or permanently attached to the band. The auxiliary implement(s) may be but are not limited to a watch, a light, a heart-rate monitor, or a combination thereof. The auxiliary implement may be a “smart” device which contains a processor that is capable of receiving computer-readable instructions and executing a series of steps based on the computer-readable instructions.

A refill pack of the device may contain a sprayable liquid. The sprayable liquid may have a viscosity of 500 cP or less at 20 degrees Celsius. The sprayable liquid may contain an antimicrobial agent such as but not limited to isopropyl alcohol or hydrogen peroxide. The sprayable liquid may be a mixture that includes the antimicrobial agent and another liquid such as water. The refill pack may be transparent such that the sprayable liquid is visible from outside the refill pack.

The refill pack may have a refill pack pressable face. The refill pack may also have additional refill pack faces configured parallel or perpendicular to the refill pack pressable face. The refill pack may be shaped similarly to the housing. For example, in embodiments wherein the housing has six flat faces defining a rectangular prism, the refill pack may also have six flat faces defining a rectangular prism. In embodiments wherein the housing has concave or convex faces, the refill pack may also have concave or convex faces to align with the shape of the corresponding housing faces. This allows the refill pack to be inserted into the housing as described further herein. It is not necessary that the shape of every refill pack face matches exactly to the shape of its corresponding housing face. For example, when the refill pack is inserted into the housing as described further herein, the refill pack pressable face may protrude from the housing, and therefore the shape of the refill pack pressable face does not need to align with the shape of any corresponding housing face.

A spray assembly of the device may comprise a spray assembly chamber. A stationary valve may be partially configured within the spray assembly chamber. The stationary valve may also extend out of the spray assembly chamber. A nozzle may be attached to the stationary valve such that the nozzle is configured outside the spray assembly chamber. The nozzle may be permanently attached to the stationary valve. The nozzle may have a nozzle aperture through which sprayable liquid may travel to exit the device via the nozzle.

A needle may also be partially configured in the spray assembly chamber. The needle may be configured opposite the stationary valve and the nozzle such that the needle extends from one end of the spray assembly chamber and the stationary valve extends from the other end of the spray assembly chamber. The needle may have a needle chamber end that is configured within the spray assembly chamber. The needle may also have a needle refill pack end configured opposite the needle chamber end. When the device is assembled as described further herein, the needle refill pack end may extend into the refill pack such that sprayable liquid from the refill pack may enter the spray assembly chamber via the needle.

A ball valve may be configured within the spray assembly chamber. The ball valve may be configured to cover and uncover the needle chamber end to control the flow of sprayable liquid entering the spray assembly chamber from the needle. The ball valve may comprise a plunger that is concentrically mated with the stationary valve within the spray assembly chamber. The plunger may translate along a length of the stationary valve when the ball valve covers and uncovers the needle chamber end.

A spring may be configured within the spray assembly chamber. The spring may be a compression spring configured around at least part of the stationary valve. The spring may also be configured around at least part of the plunger.

The housing may comprise a housing spray assembly aperture that is configured to accept the spray assembly. The spray assembly may be inserted into the housing through the housing spray assembly aperture such that the needle, the spray assembly chamber, and any components configured within the spray assembly chamber are configured within the housing. The nozzle may permanently or removably mate with the housing spray assembly aperture such that the nozzle and stationary valve remain in fixed positions (i.e. stationary) relative to the housing unless the spray assembly is intentionally disassembled from the housing. A portion of the nozzle may protrude from the housing when the nozzle is mated with the housing spray assembly aperture. In other embodiments, the nozzle may be flush with a corresponding housing face, or even recessed into a corresponding housing face when the nozzle is mated with the housing spray assembly aperture.

The housing may also comprise a refill pack aperture that is configured to accept the refill pack. The refill pack aperture may be configured on a housing face opposite the spray assembly aperture. The refill pack may be inserted into the housing via the refill pack aperture such that the refill pack is partially configured within the housing, i.e. with part of the refill pack extending from the housing. The refill pack pressable face extend from the housing so that the refill pack pressable face may be easily accessed by a user.

The refill pack may comprise a refill pack spray assembly aperture that is configured to accept at least part of the spray assembly. The part of the spray assembly accepted by the refill pack spray assembly aperture may be the needle, the spray assembly chamber, and any components configured within the spray assembly chamber. The refill pack spray assembly may include a needle aperture that extends from the rest of the refill pack spray assembly aperture towards the refill pack pressable face. When the spray assembly is accepted by the refill pack spray assembly aperture, the needle may be at least partially configured within the needle aperture. The needle refill pack end may be configured within the needle aperture or may extend through an end of the needle aperture. In either configuration, the needle refill pack end may extend into the sprayable liquid in the refill pack when the spray assembly is accepted by the refill pack spray assembly aperture.

The refill pack spray assembly aperture may comprise a spray assembly aperture seal. The spray assembly aperture seal may keep the sprayable liquid from exiting the refill pack until the spray assembly is accepted by the refill pack spray assembly aperture. When the spray assembly is accepted by the refill pack spray assembly aperture, the needle refill pack end may puncture the spray assembly aperture seal. The spray assembly aperture seal may be configured anywhere within the refill pack spray assembly aperture. In some embodiments, the spray assembly aperture seal may be configured at the end of the needle aperture closest to the refill pack pressable face. In other embodiments, the spray assembly aperture seal may be configured at the end of the needle aperture furthest from the refill pack pressable face. In other embodiments, the spray assembly aperture seal may be configured at the face of the refill pack opposite the refill pack pressable face.

When the device is fully assembled, the refill pack may be partially configured in the housing via the refill pack aperture. The spray assembly may be partially or fully configured within the housing via the housing spray assembly aperture. The spray assembly may also be partially configured within the refill pack via the refill pack spray assembly aperture. The refill pack pressable face may be pressed to translate the refill pack further into the housing. The refill pack may now be completely configured within the housing, or alternatively may still only be partially configured within the housing. When the refill pack is translated further into the housing, the refill pack may contact the spray assembly chamber and may cause the spray assembly chamber to translate towards the nozzle. This may cause the stationary valve to retract further into the spray assembly chamber. Note that the retraction of the stationary valve further into the spray assembly chamber is caused by the motion of the spray assembly chamber since the stationary valve is stationary relative to the housing.

Contact between the refill pack and the spray assembly chamber may be via the refill pack spray assembly aperture. The refill pack spray assembly aperture may have an internal face that contacts a corresponding external face of the spray assembly chamber. These faces need not be perfectly perpendicular to one another, but they should not be perfectly parallel to one another since contact between the faces must cause force to be transmitted between the refill pack spray assembly aperture and the spray assembly chamber in a direction towards the nozzle. In some embodiments, these contacting faces may be configured perfectly parallel to one another if sufficient friction exists between the faces to cause the spray assembly chamber to translate towards the nozzle when the refill pack is translated towards the nozzle. Such friction may be created by achieving a temporary press fit between the spray assembly chamber and the refill pack spray assembly aperture.

When the stationary valve is retracted further into the spray assembly chamber, the volume in the spray assembly chamber may decrease, thereby increasing the pressure within the spray assembly chamber. This increase in pressure may cause any sprayable liquid configured within the spray assembly chamber to be forced out of the device via the nozzle. The needle, spray assembly chamber, plunger, and stationary valve may all have hollow cavities that allow sprayable liquid to pass through so that sprayable liquid may enter the spray assembly via the needle and exit the spray assembly via the nozzle.

When the stationary valve is retracted further into the spray assembly chamber, the spring may be compressed. When force on the refill pack pressable face is released, the spring may extend, thereby forcing the spray assembly chamber and the refill pack to translate away from the nozzle. This may increase the volume within the spray assembly chamber, thereby decreasing the pressure within the spray assembly chamber, thereby forcing sprayable liquid from the refill pack to enter the spray assembly chamber via the needle. The refill pack pressable face may now be pressed again to once again decrease the volume within the spray assembly chamber to force the sprayable liquid that just entered the spray assembly chamber out of the device via the nozzle. This cycle may be continued until no more sprayable liquid is left in the refill pack.

When the volume in the spray assembly chamber is decreased, the increasing pressure may force the ball valve to cover the needle chamber end to prevent sprayable liquid from exiting the spray assembly chamber via the needle. When the volume in the spray assembly chamber is increased, the decreasing pressure may force the ball valve to uncover the needle chamber end to allow more sprayable liquid to enter the spray assembly chamber. The ball valve may cover and uncover the needle chamber end by translating a ball within the plunger. The ball may cover and uncover holes in the plunger that are configured adjacent to the needle chamber end. Translating the ball away from these holes allows sprayable liquid to enter the spray assembly. Translating the ball towards these holes to cover the holes blocks sprayable liquid from entering or exiting the spray assembly.

Movement of the spray assembly chamber relative to the nozzle causing sprayable liquid to enter and exit the spray assembly allows the device to function as a manual spray mechanism. The device differs from other manual spray mechanisms in that the “body” of the device (which may be the refill pack) translates, and the nozzle remains in a fixed position. In most other manual spray mechanisms, the nozzle is translated relative to the body of the spray device. In the present invention, movement of the refill pack and the spray assembly chamber allows the manual spray mechanism to be activated at a location away from the nozzle. This prevents a user from accidentally blocking the nozzle when activating the manual spray mechanism.

When the device is in use, the sprayable liquid may exit the nozzle in a direction parallel to the housing front face. The housing front face may be transparent such that the amount of sprayable liquid within the refill pack is visible to the user. When the device is worn on a user's wrist, the nozzle may be pointed distally (i.e. towards the free end of the associated limb) such that upon exiting the nozzle, the sprayable liquid is directed towards the user's hand associated with the wrist on which the device is worn. When the refill pack is empty of sprayable liquid, the user may remove the refill pack from the housing by pulling the refill pack pressable face. A secondary refill pack that contains more sprayable liquid may then be assembled to the rest of the device such that the secondary refill pack is partially configured within the housing and such that the spray assembly is partially configured within the refill pack spray assembly aperture of the secondary refill pack.

### BRIEF DESCRIPTION OF DRAWINGS

FIG. 1 shows a top front perspective view of a housing of a spray device according to embodiments of the present invention.

FIG. 2A shows a front perspective view of a refill pack of a spray device according to embodiments of the present invention.

FIG. 2B shows a front perspective cross-section view of the refill pack of FIG. 2A.

FIG. 3A shows a front view of a spray assembly of a spray device according to embodiments of the present invention.

FIG. 3B shows a front cross-section view of the spray assembly of FIG. 3A.

FIG. 4 shows an exploded front perspective view of a spray device according to embodiments of the present invention.

FIG. 5A shows a side perspective view of a spray device according to embodiments of the present invention with a refill pack being assembled into a housing.

FIG. 5B shows a front perspective view of the spray device of FIG. 5A with the refill pack fully assembled into the housing.

FIG. 6A shows a top view of a spray device according to embodiments of the present invention.

FIG. 6B shows a front view of the spray device of FIG. 6A.

FIG. 7 shows a front view of the spray device of FIG. 6A being worn on a user's appendage.

FIG. 8 shows a top perspective view of a spray device according to embodiments of the present invention.

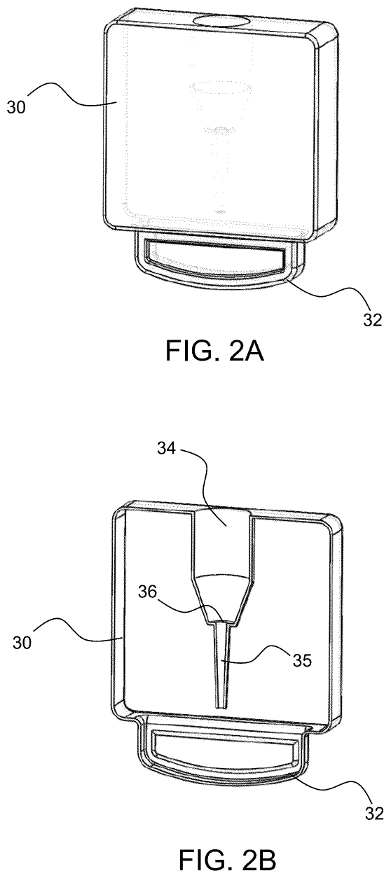

The broken lines in FIG. 2A show portions of the refill pack that may not otherwise not be visible given the view of FIG. 2A.

### DETAILED DESCRIPTION OF THE INVENTION

The description provided herein describes example embodiments of the present invention and is not intended to limit the present invention to any particular embodiment, features, components, use, functionality, shape, design, material, or any other property. Furthermore, the drawings provided herein show example embodiments of the present invention and are not intended to limit the present invention to any particular embodiment, features, components, use, functionality, shape, design, material, or any other property.

Alternative embodiments, features, components, uses, functionalities, shapes, designs, materials, or properties of the present invention may be described in U.S. Provisional Patent Application No. 63/758,303. When this disclosure, including the description, drawings, or preceding summary, contradict that of U.S. Provisional Patent Application No. 63/758,303, then these contradictions shall be interpreted as alternative embodiments of the present invention rather than contradicting inventions.

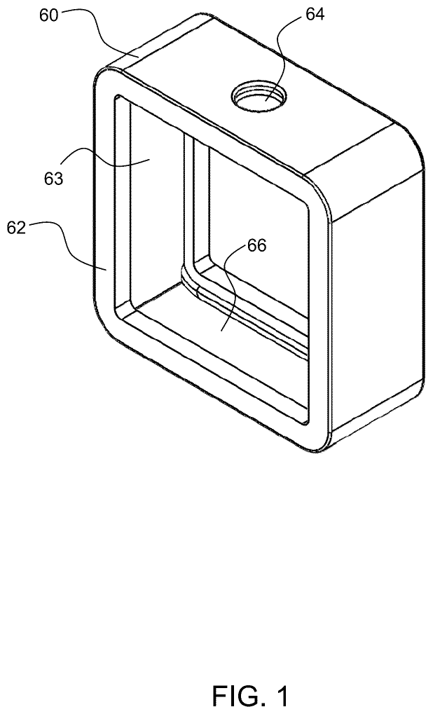

As shown in FIG. 1, a housing 60 of a spray device is a rectangular prism defining a hollow cavity 63 inside. The hollow cavity 63 is accessible via a refill pack aperture 66 at one end and a housing spray assembly aperture 64 at an opposing end. The hollow cavity 63 may also be accessible via a housing front face 62. The housing front face 62 may be open to access the hollow cavity 63. Alternatively, the housing front face may be closed such that the hollow cavity 63 cannot be accessed via the housing front face 62. In such embodiments, the housing front face 62 may be transparent such that the hollow cavity 63 is visible through the housing front face 62. In embodiments wherein the housing front face 62 is transparent, the housing front face 62 may be made of glass or a transparent plastic such as but not limited to polymethylmethacrylate, cellulose acetate butyrate, polycarbonate, or glycol modified polyethylene terephthalate.

As shown in FIG. 2A-2B, a refill pack 30 has a refill pack pressable face 32 configured opposite a refill pack spray assembly aperture 34. Part of the refill pack spray assembly aperture 34 is a needle aperture 35 that extends towards the refill pack pressable face 32. In some embodiments, the needle aperture 35 may taper in diameter as it extends in length, such that the end of the needle aperture 35 closest to the refill pack pressable face 32 has a smaller diameter than the end of the needle aperture 35 furthest from the refill pack pressable face 32. A spray assembly aperture seal 36 is configured at the end of the needle aperture 35 furthest from the refill pack pressable face 32. In alternative embodiments, the spray assembly seal 36 may be configured at the end of the needle aperture 35 closest to the refill pack pressable face 32. The spray assembly seal 36 may be secured to the refill pack spray assembly aperture 34 using an adhesive. Alternatively, the spray assembly aperture seal 36 may be formed monolithically with the refill pack 30. The refill pack 30 may be formed by plastic injection molding, and therefore all the components of the refill pack 30, including the spray assembly aperture seal 36, may be formed as a single unit (i.e. monolithically).

A sprayable liquid (not shown in FIG. 2A-2B) may be configured within the refill pack 30. The spray assembly aperture seal 36 may prevent the sprayable liquid from unintentionally exiting the refill pack 30 via the refill pack spray assembly aperture 34. If the sprayable assembly aperture seal 36 is broken, at least some of the sprayable liquid may be allowed to exit the refill pack 30 via the refill pack spray assembly aperture 34, and more specifically via the needle aperture 35.

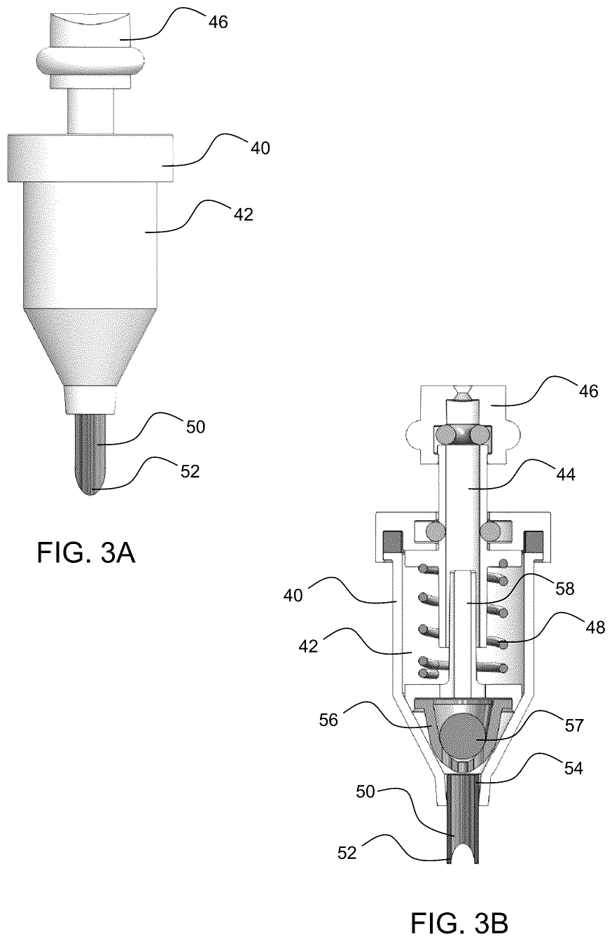

As shown in FIG. 3A-3B, one end of a stationary valve 44 of a spray assembly 40 extends into a spray assembly chamber 42 of the spray assembly 40. The other end of the stationary valve 44 is attached to a nozzle 46 of the spray assembly. The spray assembly chamber 42, stationary valve 44, and nozzle 46 are mated to one another such that the spray assembly chamber 42 may translate along the stationary valve 44 towards or away from the nozzle 46. Inside the spray assembly chamber 42, the stationary valve 44 is mated concentrically with a plunger 58 of a ball valve 56. One end of the plunger 58 surrounds a ball 57. The plunger 58 allows sufficient space for the ball 57 to translate within the plunger 58.

A needle 50 is configured at an end of the spray assembly 40 opposite the nozzle 46. The needle 50 has a needle chamber end 54 that extends into the spray assembly chamber 42 and is mated concentrically with one end of the spray assembly chamber 42. The needle also has a needle refill pack end 52 configured opposite the needle chamber end 54.

A spring 48 is configured within the spray assembly chamber 42 such that portions of the stationary valve 44 and plunger 58 extend through the spring 48. As shown in FIG. 3B, the spring 48 is a helical compression spring that contacts the plunger 58 at one end and the stationary valve 44 at the other end. This allows the plunger 58 to translate through the stationary valve 44 towards the nozzle 46 when a force is applied to the plunger 58 in a direction towards the nozzle 46. The spring 48 then forces the plunger 58 to translate away from the nozzle 46 when said force is removed.

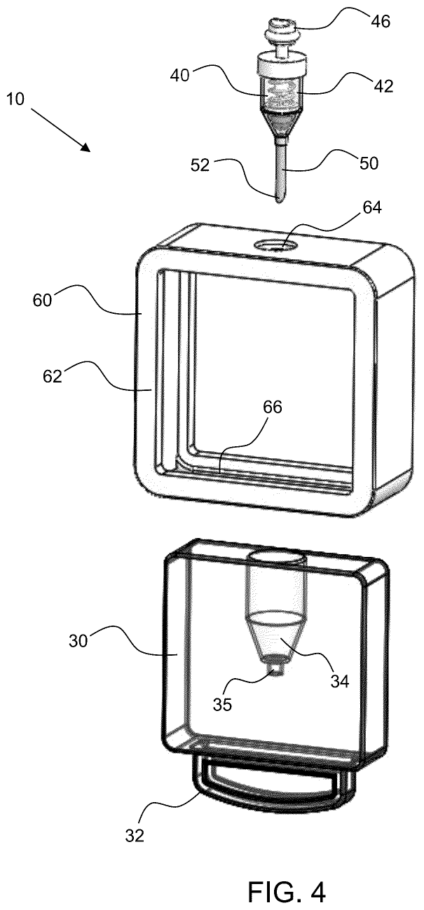

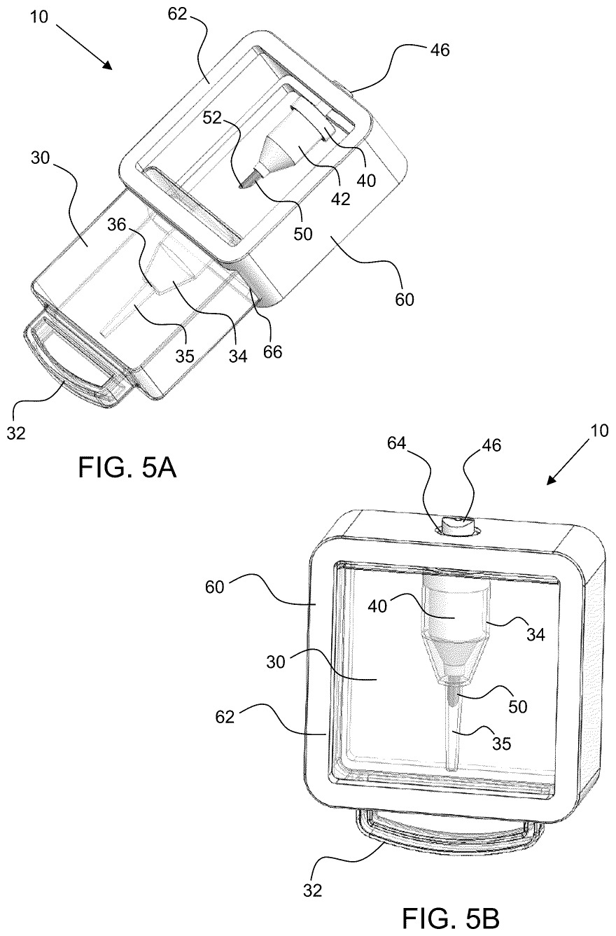

As shown in FIG. 4-5A, a spray device 10 is assembled by inserting the refill pack 30 into the refill pack aperture 66 of the housing 60 such that the refill pack spray assembly aperture 34 aligns with the housing spray assembly aperture 64. The refill pack pressable face 32 my protrude from the housing 60 when the refill pack 30 is fully inserted into the housing 60. The spray assembly 40 is inserted through the housing spray assembly aperture 64 and into the refill pack spray assembly aperture 34 such that the needle 50 is configured within the needle aperture 35. The needle refill pack end 52 punctures the spray assembly aperture seal 36 when the needle 50 is inserted into the needle aperture 35.

The nozzle 46 is secured in the housing spray assembly aperture 64. The nozzle 46 may be secured in the housing spray assembly aperture 64 by a ring extending outward from a circumference of the nozzle 46 that mates with a corresponding annular divot extending inward from a circumference of the housing spray assembly aperture 64. Said rings may be referred to as “annular snap features” in U.S. Provisional Patent Application No. 63/758,303. When the nozzle 46 is secured to the housing spray assembly aperture 64, a portion of the nozzle 46 may extend from the housing 60 away from the refill pack aperture 66.

At least a portion of the spray assembly chamber 42 is configured in the refill pack spray assembly aperture 34 when the spray device 10 is assembled. The refill pack 30 may be configured to move within the housing 60 towards the nozzle 46 and away from the nozzle 46. When the refill pack pressable face 32 is pressed towards the nozzle 46, the refill pack 30 may translate in the housing 60 towards the nozzle 46. The mating between the refill pack 30 and the spray assembly 40 via the refill pack spray assembly aperture 34 may cause the spray assembly chamber 42 to also translate towards the nozzle 46. This causes the plunger 58 of the spray assembly 40 to translate towards the nozzle 46, which reduces the volume in spray assembly chamber 42 and thereby increases the pressure in the spray assembly chamber 42. This also causes the spring 48 to compress.

When force on the refill pack pressable face 32 is released, the spring 48 extends, causing the plunger 58 to translate away from the nozzle 46, causing the spray assembly chamber 42 to translate away from the nozzle 46, thereby increasing the volume in the spray assembly chamber 42 and thereby decreasing the pressure in the spray assembly chamber 42. When the pressure in the spray assembly chamber 42 decreases, sprayable liquid from the refill pack 30 may be pulled into the spray assembly chamber through the needle 50. When the refill pack pressable face 32 is once again pressed towards the nozzle 46 causing the plunger 58 to translate towards the nozzle 46 to decrease the volume inside the spray assembly chamber and thereby increasing the pressure inside the spray assembly chamber 42, the sprayable liquid inside the spray assembly chamber 42 may be forced out of the spray assembly 40 via the nozzle 46. When force on the refill pack pressable face 32 is once again released, the spring 48 may once again extend to cause the plunger 58 to once again translate away from the nozzle 46, thereby increasing the volume in the spray assembly chamber 42 and decreasing the pressure in the spray assembly chamber 42, causing more of the sprayable liquid to enter the spray assembly chamber 42 from the refill pack 30 via the needle 50.

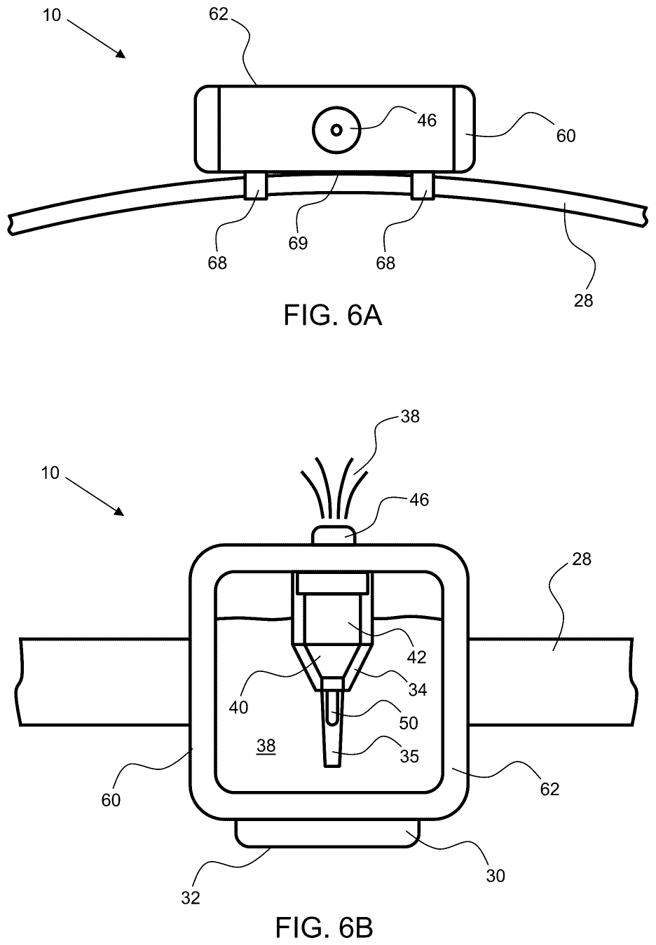

As shown in FIG. 6A, two band attachment loops 68 protrude from a housing rear face 69 configured opposite the housing front face 62. A band 28 is configured through the band attachment loops 68 to secure the housing 60 to the band. As shown in FIG. 6B, sprayable liquid 38 configured within the refill pack 30 can be forced out of the spray device 10 via the nozzle 46 by pressing the refill pack pressable face 32 towards the nozzle 46. The sprayable liquid 38 may exit the nozzle 46 as a spray, a mist, or a combination thereof. A “mist” may be defined as a pattern of liquid traveling through the air with droplet sizes being 50 microns or less. A “spray” may be defined as a pattern of liquid with droplet sizes of liquid traveling through the air with droplet sizes greater than 50 microns. A mist may be useful for covering a wider area with the sprayable liquid, whereas a spray may be useful for covering a targeted area with the liquid. The spray may also be effective in allowing the sprayable liquid to travel a greater distance from the nozzle 46. Note that the terms “mist” and “spray” may be used interchangeably in U.S. Provisional Patent Application No. 63/758,303 but are further defined herein.

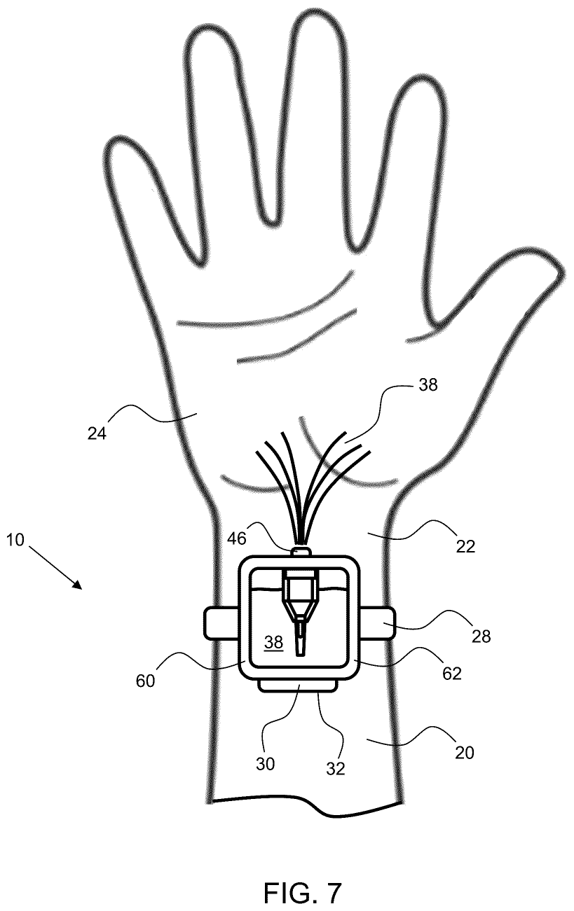

As shown in FIG. 7, the band 28 is worn around a user's appendage 20, which is shown as a user's wrist 22 in FIG. 7. The housing 60 is attached to the band 28 such that the nozzle 46 of the spray device 10 is pointed towards the user's hand 24 associated with the user's wrist 22 around which the band 28 is worn. Pressing the refill pack pressable face 32 causes sprayable liquid 38 to exit the spray device 10 via the nozzle 46 and make contact with the user's hand 24. The refill pack pressable face 32 may be pressed towards the nozzle 46 by the user's other hand (not shown in FIG. 7). Though the sprayable liquid 38 is shown to make contact with the palm (i.e. “front”) of the user's hand 24 in FIG. 7, the device 10 may alternatively be worn such that when the refill pack pressable face 32 is pressed, sprayable liquid 38 makes contact with the back of the user's hand 24.

As shown in FIG. 6B-7, the sprayable liquid 38 exits the nozzle 46 in a direction parallel to the housing front face 62. This may mean that the general direction of the sprayable liquid 38 is parallel to the housing front face 62. Some of the sprayable liquid 38 may exit the nozzle 46 at angles relative to the general direction of the sprayable liquid 38 as shown in FIG. 6B-7.

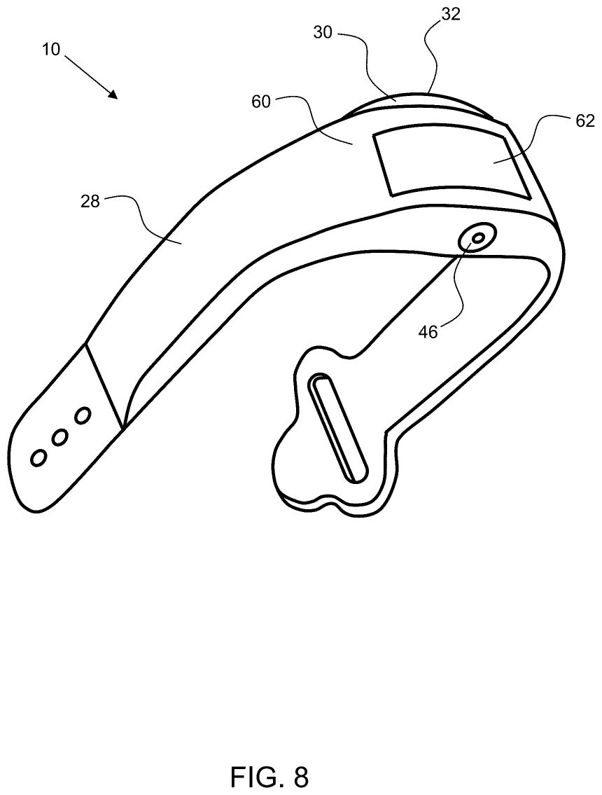

As shown in FIG. 8, the housing 60 is integrally formed with the band 28 in some embodiments of the spray device 10. The housing front face 62 has a transparent window through which a portion of the refill pack 30 is visible. This allows a user to view the amount of sprayable liquid left in the refill pack 30. In embodiments of the spray device 10 shown in FIG. 8, the refill pack 30 may still be removable from the housing 60. The refill pack pressable face 32 may still be configured opposite the nozzle 46, and may still be pressed towards the nozzle 46 to cause sprayable liquid to exit the spray device 10 via the nozzle 46.

1. A device comprising:
a band configured around an appendage of a user;
a refill pack containing sprayable liquid and comprising a refill pack pressable face;
a spray assembly comprising:
a spray assembly chamber;
a stationary valve partially configured within the spray assembly chamber and extending out of the spray assembly chamber;
a nozzle attached to the stationary valve, the nozzle being configured outside the spray assembly chamber;
a spring configured within the spray assembly chamber;
a needle extending from the spray assembly chamber into the refill pack, the needle comprising a needle refill pack end and a needle chamber end;
a housing attached to the band, the housing comprising:
a housing front face;
a housing spray assembly aperture configured to accept the spray assembly;
a refill pack aperture configured to accept the refill pack whereby the refill pack is partially configured within the housing;
wherein the refill pack pressable face is pressed to translate the refill pack further into the housing,
wherein the refill pack contacts the spray assembly chamber and causes the spray assembly chamber to translate whereby the stationary valve is retracted further into the spray assembly chamber,
wherein the pressure within the spray assembly chamber increases, causing sprayable liquid within the spray assembly chamber to exit the spray assembly via the nozzle.

2. The device of claim 1, wherein the refill pack is released,
wherein the spring forces the refill pack to translate away from the nozzle,
wherein the stationary valve extends further out of the spray assembly chamber,
wherein the pressure within the spray assembly chamber decreases, causing some of the sprayable liquid from the refill pack to move into the spray assembly chamber.

3. The device of claim 1, wherein the stationary valve and the nozzle are stationary relative to the housing.

4. The device of claim 1, wherein the refill pack aperture is configured opposite the housing spray assembly aperture.

5. The device of claim 1, wherein the housing is removably attached to the band.

6. The device of claim 5, wherein the housing comprises band attachment loops through which the band is configured to removably attach the housing to the band.

7. The device of claim 1, wherein an auxiliary implement is attached to the band.

8. The device of claim 7, wherein the auxiliary implement is a watch.

9. The device of claim 7, wherein the auxiliary implement is a light.

10. The device of claim 1, wherein the housing is integrally formed with the band.

11. The device of claim 1, wherein the sprayable liquid exits the nozzle in a direction parallel to the housing front face.

12. The device of claim 1, wherein the refill pack is visible through the housing front face.

13. The device of claim 1, wherein the band is worn around a user's wrist,
wherein the nozzle is pointed distally,
wherein upon exiting the nozzle, the sprayable liquid is directed towards the user's hand associated with the user's wrist around which the band is worn.

14. The device of claim 1, wherein the refill pack comprises a refill pack spray assembly aperture configured to accept the spray assembly,
whereby the needle extends into the sprayable liquid within the refill pack when the spray assembly is accepted by the refill pack spray assembly aperture.

15. The device of claim 14, wherein the refill pack spray assembly aperture comprises a spray assembly aperture seal that is punctured by the needle when the spray assembly is accepted by the refill pack spray assembly aperture.

16. The device of claim 15, wherein the refill pack spray assembly aperture comprises a needle aperture,
wherein the spray assembly aperture seal is configured within the needle aperture.

17. The device of claim 1, wherein the spray assembly further comprises a ball valve configured to cover the needle chamber end when the refill pack is pressed further into the housing,
and wherein the ball valve is configured to uncover the needle chamber end when the refill pack is forced to translate away from the nozzle.

18. The device of claim 17, wherein the ball valve comprises a plunger that is concentrically mated with the stationary valve.

19. The device of claim 1, wherein the sprayable liquid contains an antimicrobial agent.

20. The device of claim 1, wherein the refill pack is completely removed from the housing,
wherein a secondary refill pack containing sprayable liquid is accepted by the refill pack aperture whereby the secondary refill pack is partially configured within the housing.
